(19) United States
(12) Patent Application Publication
(10) Pub. No.: US 2026/0110792 A1
(43) Pub. Date: Apr. 23, 2026

(54) USE OF A PORTABLE IDENTIFIER WITH TWO COMMUNICATION PROTOCOLS

(71) Applicant: Valeo Comfort and Driving Assistance, Créteil (FR)

(72) Inventor: Herve Farine, Créteil (FR)

(73) Assignee: Valeo Comfort and Driving Assistance, Créteil (FR)

(21) Appl. No.: 19/365,400

(22) Filed: Oct. 22, 2025

(30) Foreign Application Priority Data
Oct. 22, 2024 (FR) 2411511

(51) Int. Cl. G01S 13/74

(52) U.S. Cl. CPC G01S 13/74

(57) ABSTRACT

Described is a method for using a portable identifier to communicate with a vehicle system using a first communication protocol and a second communication protocol. The portable identifier includes an electrical energy source. The method includes determining the remaining energy level in the electrical energy source, measuring the temperature, detecting that the determined remaining energy level is below a predetermined energy threshold and that the measured temperature is below a predetermined temperature threshold, and then changing the communication from the first communication protocol to the second communication protocol. The second communication protocol is configured so that the voltage across the terminal of the electrical power source remains above a predetermined voltage threshold.

### TECHNICAL FIELD

The present disclosure relates to a method for using a portable identifier communicating with a vehicle system, a computer program for such a portable identifier, a storage medium for such a program and a portable identifier for executing such a method.

TECHNICAL BACKGROUND

Vehicles currently exist that are equipped with systems that have registered one or more portable identifiers. These portable identifiers can be portable devices such as key fobs or smartphones. Each portable identifier comprises an electrical energy source (for example, a battery) that allows it to be portable. Such systems allow the vehicle to perform functions, such as, for example, opening the doors and/or starting the vehicle, as a function of the location of the one or more portable identifiers.

In order to perform these functions, each portable identifier can be configured to communicate with the system using a UWB (Ultra Wide Band) communication protocol. This protocol notably can allow the portable identifier to be localised around the vehicle by means of several successive UWB exchanges between anchors of the system and the portable identifier. However, these UWB exchanges consume a significant amount of energy, which can lead to localisation failures when insufficient energy is available in the identifier.

Therefore, a requirement exists to improve the use of these portable identifiers and notably their ability to be localised by the system.

### SUMMARY

To this end, a method is proposed for using a portable identifier configured to communicate with a vehicle system using a first communication protocol and a second communication protocol. The portable identifier comprises an electrical energy source. The method comprises determining the remaining energy level in the electrical energy source. The method comprises measuring the temperature. The method comprises detecting that the determined remaining energy level is below a predetermined energy threshold and that the measured temperature is below a predetermined temperature threshold. The method comprises, following the detection step, changing the communication from the first communication protocol to the second communication protocol. The second communication protocol is configured so that the voltage across the terminal of the electrical energy source remains above a predetermined voltage threshold.

The communication can involve successively localising the portable identifier relative to the vehicle. Each localisation can involve UWB exchanges between the portable identifier and the vehicle system. The localisations can be carried out, after changing the communication protocol, using the second communication protocol.

The localisations carried out using the second communication protocol involve fewer UWB exchanges than the localisations carried out using the first communication protocol.

The vehicle system can include anchors. The UWB exchanges for each localisation can involve the portable identifier receiving signals sent by the anchors of the system. The number of signals received for each localisation carried out using the second communication protocol can be less than the number of signals received for each localisation carried out using the first communication protocol.

The time spacing between the UWB exchanges for the localisations carried out using the second communication protocol can be greater than the time spacing between the UWB exchanges for the localisations carried out using the first communication protocol.

The UWB exchanges for each localisation can involve the portable identifier transmitting signals to the system. The strength of the transmissions of the second protocol can be lower than the strength of the transmissions of the first communication protocol.

The portable identifier and/or the system can further comprise a memory storing a calibration table. The calibration table can include communication protocol parameters to be applied as a function of temperature and energy thresholds. The method can comprise determining the parameters of the second communication protocol by reading the calibration table.

The temperature measurement step can be carried out by the portable identifier or by the vehicle system.

A computer program is also proposed for such a portable identifier. The computer program comprises instructions which, when the program is executed by a processor of the portable identifier, cause the processor to implement such a method.

A computer-readable storage medium is also proposed that stores such a computer program.

A portable identifier is also proposed. The portable identifier comprises such a storage medium. The portable identifier is configured to execute such a method.

### BRIEF DESCRIPTION OF THE FIGURES

Non-limiting examples will be described with reference to the following figures:

FIG. 1 illustrates an example of a flowchart of the method;

FIG. 2 illustrates an example of a vehicle system and of the portable identifier;

FIG. 3 and FIG. 4 illustrate an example of a portable identifier;

FIG. 5 illustrates an example of localisation between a vehicle system and a portable identifier;

FIG. 6 and FIG. 7 illustrate examples of results;

FIG. 8, FIG. 9 and FIG. 10 illustrate examples of localisations carried out using the second communication protocol;

FIG. 11 shows an example of a calibration table;

FIG. 12 and FIG. 13 illustrate examples of the architecture of the portable identifier.

### DETAILED DESCRIPTION

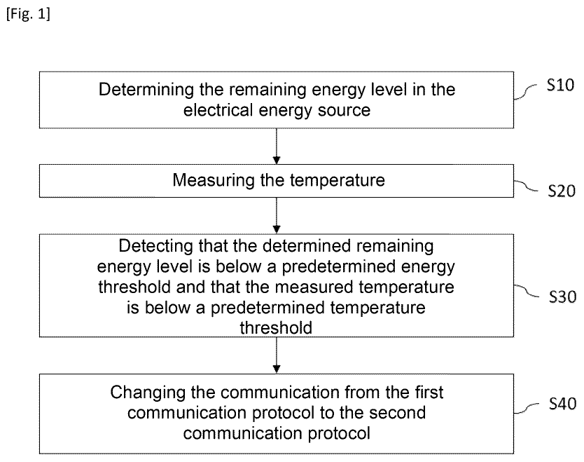

With reference to the flowchart of FIG. 1, a method is proposed for using a portable identifier configured to communicate with a vehicle system using a first communication protocol and a second communication protocol. The identifier comprises an electrical energy source. The method comprises determining S10 the remaining energy level in the electrical energy source. The method comprises measuring S20 the temperature. The method comprises detecting S30 that the determined remaining energy level is below a predetermined energy threshold and that the measured temperature is below a predetermined temperature threshold. The method comprises, following the detection step S30, changing S40 the communication from the first communication protocol to the second communication protocol. The second communication protocol is configured so that the voltage across the terminal of the electrical energy source remains above a predetermined voltage threshold.

The method improves the use of the portable identifier.

Indeed, the method reduces the risk of the system interrupting the communication between the portable identifier. Such an interruption notably can occur when the temperature is low and the energy level available in the portable identifier becomes insufficient. Indeed, in such a situation, the tank capacitor of the portable identifier can be insufficient for carrying out several successive UWB exchanges between the system and the portable identifier, such as when localising the portable identifier. When there is a risk of this occurring, the method changes the communication so that it is carried out according to a second communication protocol, in which the voltage across the terminal of the electrical energy source remains above a predetermined voltage threshold. With this second protocol, all the successive UWB exchanges therefore can be carried out, despite the low temperature and the low energy level. The method therefore allows communication to be maintained between the portable identifier and the system, avoiding any interruption, for example, of the localisation of the portable identifier, which might otherwise occur.

In particular, the method allows both the remaining energy level and also the measured temperature to be taken into account, which improves the detection of a risk situation. Indeed, a low energy level is particularly problematic when the temperature drops. The method therefore ensures that the transition from the first protocol to the second protocol only occurs when there is an actual risk of interruption. In other words, the method allows the communication to be maintained as long as possible by using the first (more complete) protocol, and only transitions to the second (more limited) protocol when there is an actual risk of interruption. In other words, the method allows the communication protocol that is used to be dynamically adjusted as a function of the remaining energy level, which ultimately improves the overall quality of the communication.

The operating method can be performed while a UWB communication is ongoing between the portable identifier and the vehicle system. The portable identifier and the system can communicate, for example, when the portable identifier is within a certain perimeter around the vehicle, for example, when the user carrying the portable identifier is located inside the vehicle, or when the user approaches or moves away from the vehicle.

Such a UWB communication can involve successive localisations, for example, over a certain periodicity, of the portable identifier relative to the vehicle. Each of these localisations can include UWB exchanges between the portable identifier and the vehicle system. Initially, i.e., before performing steps S10 to S40, the communication protocol used by the communication is the first communication protocol. The localisations are therefore carried out using the first communication protocol. After performing steps S10 to S40, the communication is changed, and the communication protocol that is used becomes the second communication protocol. The localisations are therefore carried out using this second communication protocol.

The operating method can include determining the position of the portable identifier based on localisations that were performed during the communication. For example, localising can involve providing a relative position of the portable identifier relative to the UWB system. In particular, each localisation can involve UWB exchanges between the portable identifier and several UWB anchors (also called “sensors”) of the system (for example, all the anchors) in order to determine the respective distances between the portable identifier and each of the anchors. Each localisation can then involve determining the relative position of the portable identifier relative to the UWB system based on determined distances (with the position corresponding, for example, to the intersection of circles plotted from the anchors and having the computed distances as diameters).

Each distance to an anchor can be measured by exchanging a UWB signal between the identifier and the anchor and computing a time of flight between the identifier and the anchor during this exchange. This time of flight can be the time taken by the exchanged signal to travel to and from the identifier and the system. The time of flight can be computed by the identifier or the anchor, and can be carried out in any manner. For example, each measurement can include recordings of the times at which the exchanged signal is sent and received, and the computation can be carried out by using these recordings to deduce the time taken by the signal to complete the round-trip. Each measurement can then involve deducing the distance between the identifier and the anchor based on this time of flight. For example, each measurement can include multiplying a speed of the signal by the computed time of flight. The speed of the signal can be, for example, a predetermined and known speed for this type of signal (for example, stored in the memory of the identifier or of the system).

The successive localisations carried out during the communication can allow the position of the portable identifier to be determined in real time. For example, each localisation can provide a position of the portable identifier relative to the UWB system at a given instant, and all the completed localisations can provide an indication of the evolution of its position over time. The operating method thus can involve determining the evolution of the position of the portable identifier based on successive localisations carried out using the first or the second communication protocol.

The operating method can also include one or more uses of the determined relative positions of the portable identifier. For example, the operating method can involve activating one or more functionalities of the vehicle as a function of the position of the portable identifier. For example, the functionality can involve closing the vehicle when the portable identifier is determined as being located outside the vehicle, for example, after a predetermined duration has elapsed between the moment when the portable identifier has been determined as being located outside. In some examples, the functionality can involve selectively unlocking one or more openings of the vehicle (for example, a driver door, a passenger door or a boot of the vehicle) as a function of the determined relative positions of the portable identifier. For example, the functionality can involve unlocking the driver door or the boot of the vehicle when the portable identifier approaches the driver door or the boot. In yet more examples, the functionality can include activating one or more vehicle functions, such as turning on music or adjusting mirrors according to the person carrying the portable identifier located on the driver seat. The operating method can include any combination of these examples of functionality.

Each step of the method will now be described in further detail.

The step S10 of determining the remaining energy level can be performed by the portable identifier. In a first example, determining S10 the energy level can involve measuring the no-load voltage of the battery and the charging voltage, then computing the internal resistance of the energy source (for example, the battery) based on the difference between these two voltages (for example, using the formula U=E−r*I, thus by computing r=(E−U)/I, with E being the no-load voltage, U being the charging voltage, r being the internal resistance and I being the charging current). Determining S10 the energy level can then involve deducing the remaining energy level as a function of the value of the computed internal resistance. Alternatively, in a second example, the portable identifier can include an electronic component configured to measure the remaining energy level in the electrical energy source, such as a voltage converter (also called “voltage booster”). Such a component can be configured, for example, to supply the amount of energy (for example, the number of mAh) that has been consumed on the electrical energy source. The remaining energy level then can be deduced from this amount of consumed energy, for example, by subtracting this amount of consumed energy from a total amount of energy available in the energy source prior to consumption.

The step S20 of measuring the temperature can be performed by the portable identifier. The portable identifier can include an electronic component configured to measure the temperature experienced by the portable identifier, either by the UWB component or the BLE component, or by adding a temperature sensor. The measurement step S20 can involve this sensor measuring the temperature. Alternatively, this step can be carried out by the vehicle system, for example, with a temperature sensor placed in the vehicle.

The step S30 of detecting that the determined remaining energy level is lower than the predetermined energy threshold, and that the measured temperature is lower than the predetermined temperature threshold, can be performed while the steps of determining S10 the remaining energy level and of measuring S10 the temperature are performed. The steps of determining S10 the remaining energy level and of measuring S10 the temperature can be carried out continuously, for example, at a certain frequency (identical or different), so as to provide the remaining energy level and the experienced temperature at each instant. For each new measurement of the temperature or of the remaining energy level, the method can involve comparing the new measurement with the corresponding threshold (energy threshold for the remaining energy level and temperature threshold for the measured temperature). The method can then detect S30 that the determined remaining energy level is below a predetermined energy threshold and that the measured temperature is below a predetermined temperature threshold when the comparison indicates that the new measured values drop below the predetermined thresholds.

The energy threshold can represent a minimum amount of energy remaining in the energy source. For example, the energy threshold can be expressed as a percentage of the maximum amount of energy that can be stored in the energy source, and can represent a minimum percentage of remaining energy, for example, ranging between 50 and 75 %. In this case, the determined remaining energy also can be expressed as a percentage, for example, relative to the maximum energy of the energy source. The temperature threshold for its part can represent a minimum temperature not to be exceeded. The temperature threshold can, for example, range between 10 and −10° C. The temperature threshold can be equal to 0° C., for example.

The step S30 of detecting that the determined remaining energy level is lower than the predetermined energy threshold, and that the measured temperature is lower than the predetermined temperature threshold, can be carried out by the portable identifier. In this case, the portable identifier can be configured to store the values of the remaining energy level and of the measured temperature (for example, continuously), for example, on a memory. Then, the portable identifier can be configured to compare these values with the predetermined energy and temperature thresholds. Alternatively, the detection step S30 can be carried out by the vehicle system. In this case, the portable identifier can be configured to send the measured remaining energy level and temperature values to the vehicle system, which for its part can be configured to compare them with the predetermined thresholds (after, for example, storing them in a memory of the vehicle).

The changing step S40 is carried out immediately after the detection step S30. In other words, when the determined remaining energy level has been detected as being lower than the predetermined energy threshold and the measured temperature has been detected as being lower than the predetermined temperature threshold, the change to the second protocol is performed. The UWB localisations between the system and the portable identifier then can be carried out using this second protocol. The change S40 can be carried out by the portable identifier and/or the system. The change S40 can involve the portable identifier sending the system a signal including, for example, the measured temperature and/or the remaining energy level. The change S40 can then involve receiving the signal sent by the system, and selecting the second protocol to be implemented by the system, for example, as a function of the measured temperature and/or of the remaining energy level. The system can include, for example, a memory that stores a calibration table. This calibration table can include communication protocol parameters to be applied as a function of the temperature and energy thresholds. For example, each row of the table can include a respective range for the temperature and energy level values and the associated protocol parameters. The reading can include identifying the corresponding row as a function of the measured values, and deducing the parameters to be used. In this case, the method can involve determining the parameters of the second communication protocol by reading the calibration table. The second protocol then can be sent to the portable identifier in order to be used.

Alternatively, the portable identifier can be configured to offer the system a second protocol. In this case, it is the portable identifier that may include a memory that stores the aforementioned calibration table. The portable identifier can be configured to determine the parameters of the second communication protocol to be used by reading this calibration table (in the same way as the system, for example). The signal sent by the portable identifier can then include the determined parameters of this second protocol. The change S40 can then involve the system confirming this proposal, and sending, for example, the portable identifier a message confirming the proposed new protocol. Alternatively, once again, the table may be available both to the system and to the portable identifier, and one can thus, for example, check the solution proposed by the other.

The second communication protocol is configured so that the voltage across the terminals of the electrical energy source remains above a predetermined voltage threshold. This means that the parameters of this protocol allow the battery voltage to remain above this voltage threshold, notably for each localisation carried out with the UWB system of the vehicle. The remaining energy in the energy source is sufficient to be able to carry out each localisation without the voltage dropping below the predetermined voltage threshold.

In a first example of an implementation, the second protocol can reduce the number of UWB exchanges carried out for each localisation. For example, in the first protocol, each localisation can include measurements of distances to all the anchors in the system, while in the second protocol, each localisation can include measurements with fewer anchors (for example, at least two), thereby reducing the number of completed exchanges, and as a result the energy that is used. Each distance measurement to an anchor can involve the anchor sending a signal to the portable identifier, and therefore the portable identifier receiving this signal. In the first protocol, the portable identifier can receive the signals sent by all the anchors of the system, whereas in the second protocol, the portable identifier can only pick-up a limited number of anchors of the system (for example, at least two), and therefore only receive the signals from this limited number of anchors. The anchors that are picked-up can be selected by the portable identifier or the system, and may or may not vary for each completed localisation. For example, the system can suggest anchors to the portable identifier based on its position, for example, the position measured during the last localisation. The suggested anchors can be, for example, those that are furthest away on either side of the vehicle relative to the position of the portable identifier, which allows better measurement accuracy to be maintained.

In a second example of an implementation, the second protocol can increase the time spacing between the UWB exchanges for each localisation. For example, each localisation can involve successive exchanges of signals between the portable identifier and several anchors of the system (for example, all the anchors), and the exchanges of signals can be more spaced apart in the second communication protocol than in the first. The time spacing between the exchanges can correspond to the time interval between two successive exchanges, i.e., between the end instant of the first and the start instant of the second. The time spacing between all the exchanges of the localisation can be greater than a first duration in the first protocol, and greater than a second duration in the second protocol, and the first duration can be less than the second duration. The time spacing between all the exchanges of the localisation can be greater than or equal to 4,000 μs in the second protocol, for example. This allows the energy that is used to be more spaced apart, and therefore allows the voltage in the energy source to rise between the various exchanges, and therefore to remain above the predetermined voltage threshold.

In a third example of an implementation, the second protocol can reduce the transmission strength of signals transmitted by the portable identifier. For each localisation, the portable identifier can send signals to the system and to each anchor of the system, for example, in order to carry out distance measurements. In the first protocol, the signals sent by the portable identifier can be sent with a first strength level, and in the second protocol the signals can be sent with a second strength level lower than the first strength level. This allows less energy to be used for each sent signal, and thus allows the voltage to remain above the predetermined voltage threshold.

In some examples, the method can combine any of the first, second and third examples of implementations discussed above. For example, the second protocol can both reduce the number of UWB exchanges (as in the first example of an implementation) and increase the time spacing between this reduced number of UWB exchanges (as in the second example of an implementation). Alternatively, the second protocol can both reduce the number of UWB exchanges (as in the first example of an implementation) and reduce the strength of the sent signals (as in the third example of an implementation). Alternatively, the second protocol can both increase the time spacing between the UWB exchanges (as in the second example of an implementation) and reduce the strength of the sent signals (as in the third example of an implementation). Alternatively, the second protocol can equally reduce the number of UWB exchanges (as in the first example of an implementation), increase the time spacing between this reduced number of UWB exchanges (as in the second example of an implementation) and reduce the strength of the sent signals (as in the third example of an implementation).

In some examples, the vehicle system may have registered multiple portable identifiers. In this case, when a user carrying one of these portable identifiers is approaching the vehicle, the steps of the method can be performed for this identifier. When another one of the portable identifiers approaches the vehicle (for example, by being carried by the same user or by another user), the method can be repeated for this other identifier.

The UWB communication can continue, for example, until the user enters the vehicle or starts the vehicle (for example, starts the engine of the vehicle). At this moment, the UWB communication can vary. For example, when the user enters the vehicle or starts the vehicle, the localisation frequency can decrease.

The electrical energy source can be a battery. For example, the electrical energy source can be a button battery. The battery can have a large electrical capacity, for example, an electrical capacity of more than 320 mAh. The battery can have, for example, an electrical capacity of 620 mAh. The battery can be, for example, a CR2450 button battery.

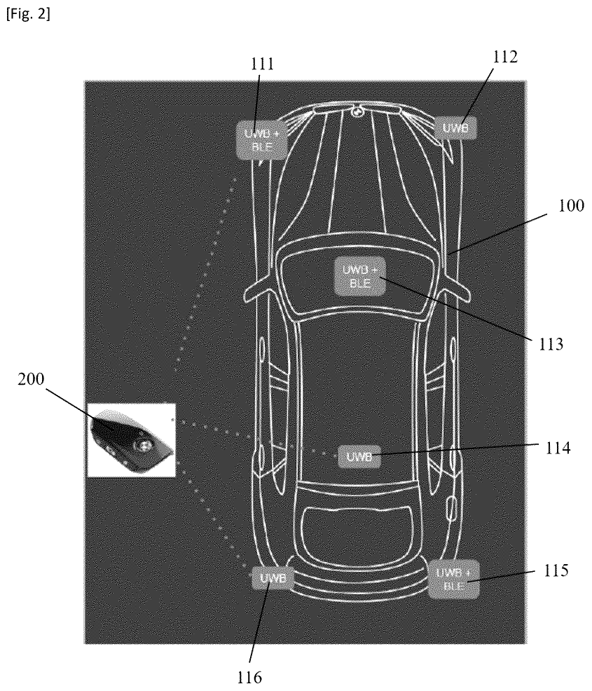

Some examples will now be described with reference to FIGS. 2 to 13.

FIG. 2 illustrates an example of a vehicle system 100 and of a portable identifier 200. The system comprises anchors 111, 112, 113, 114, 115 and 116 positioned at various locations on the vehicle 100. The portable identifier 200 is a key fob in this example.

The portable identifier and the system are configured to communicate with each other, notably localising the portable identifier 200 around the vehicle 100. The communication between the portable identifier 200 and the vehicle system involves successive UWB localisations of the portable identifier 200 around the vehicle 100 in order to compute the position of the portable identifier 200 around the vehicle 100 in real time. Each UWB localisation involves UWB exchanges between the portable identifier 200 and the anchors 111, 112, 113, 114, 115 and 116 of the system in order to determine the respective distances between the portable identifier 200 and each of the anchors 111, 112, 113, 114, 115 and 116. Each localisation then involves determining the relative position of the portable identifier 200 relative to the UWB system based on determined distances to each anchor 111, 112, 113, 114, 115 and 116.

Each distance to an anchor is measured by exchanging a UWB signal between the identifier and the anchor and computing a time of flight between the identifier and the anchor during these exchanges. This time of flight can be the time taken by the exchanged signal to travel to and from the identifier and the system. The time of flight can be computed by the identifier, and can be carried out in any manner. For example, each measurement can include recordings of the times at which the exchanged signal is sent and received, and the computation can be carried out by using these recordings to deduce the time taken by the signal to complete the round-trip. Each measurement can then involve deducing the distance between the identifier and the anchor based on this time of flight. The times of flight then can be sent, for example, to all the anchors (for example, by sending the same frame with all the times of flight), and each anchor can compute the position of the identifier relative to itself using the sent times of flight. For example, each measurement can include multiplying a speed of the signal by the computed time of flight. The speed of the signal can be, for example, a predetermined and known speed for this type of signal (for example, stored in the memory of the identifier or of the system). All this information then can be sent to the main computer, which can deduce the exact position of the identifier therefrom (relative to the centre of the vehicle).

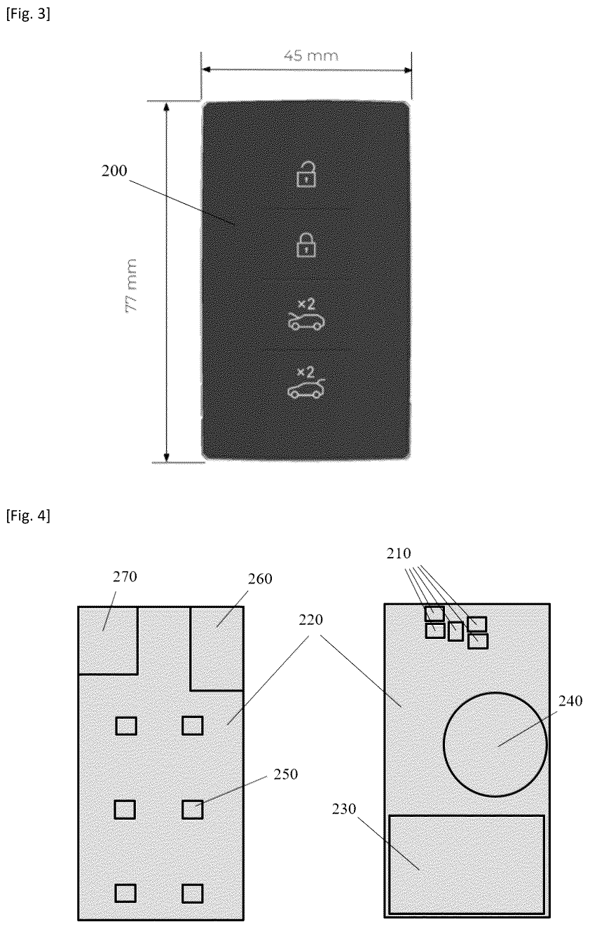

FIG. 3 shows an example of a 45 mm wide and 77 mm long casing. FIG. 4 illustrates an example of a portable identifier printed circuit, and in particular the two faces 201, 202 of this circuit. Such a circuit can be located inside the casing illustrated in FIG. 3. The circuit comprises antennae 230, 270, 260, a battery 240 and six buttons 250. During each localisation, the energy is taken from a tank capacitor made up of a plurality of capacitors 210. Since the dimensions of a portable identifier are limited, the space available for these capacitors 210 is limited, which reduces the achievable tank capacitor. Therefore, the problem of localisation failures cannot be solved by increasing the tank capacitor in the casing. For example, in order to obtain a tank capacitor of 430 μF with SMD capacitors each with a maximum capacity of 47 μF, more than 10 capacitors would be required (taking into account degradation of 25 %). However, this is not possible due to the dimensions of the casing. The dimensions of the casing can range, for example, between 20 and 40 mm wide and 40 to 70 mm long. The portable identifier can include between 2 and 5 capacitors at most. This can represent a tank capacitor ranging between 125 μF and 350 μF, for example, between 150 μF and 250 μF. The tank capacitor can be, for example, equal to 164 μF or 250 μF. The portable identifier can only contain a maximum of 5 capacitors, and more capacitors cannot be added without increasing the size of the PCB, and therefore that of the casing. The method overcomes this problem by reducing the risk of a localisation failure without increasing the size of the casing.

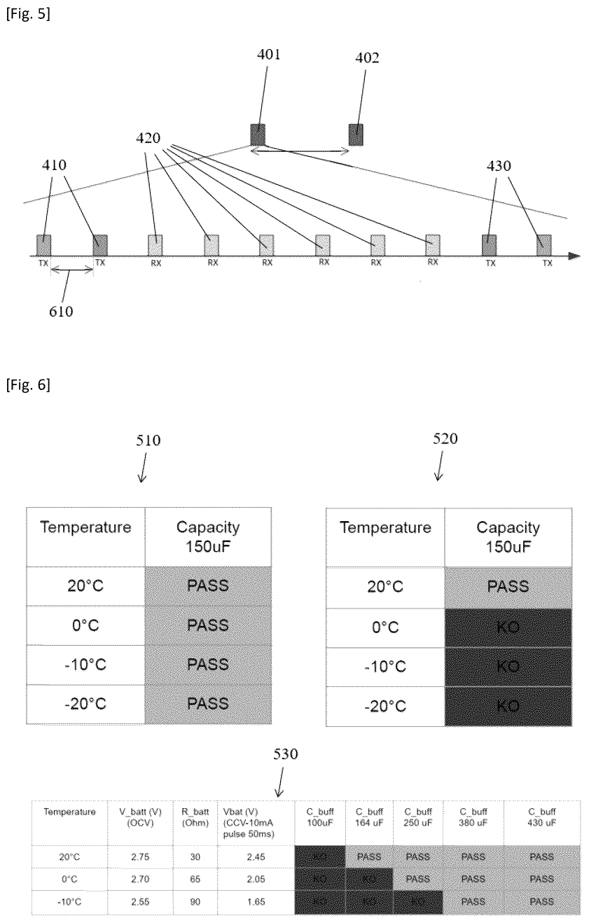

FIG. 5 illustrates an example of communication between the vehicle system 100 and the portable identifier 200 of FIG. 2. The communication comprises successive UWB localisations 401, 402 between the vehicle system 100 and the portable identifier 200. The successive UWB localisations 401, 402 are carried out in this figure using the first communication protocol.

Each localisation comprises UWB exchanges 410, 420, 430 in order to determine the respective distances between the portable identifier and the UWB anchors of the system and involves determining the relative position of the portable identifier relative to the UWB system based on the determined distances. In particular, the localisation comprises two transmissions 410 of a frame over two first time slots 410 from the UWB portable identifier to each of the UWB anchors of the system. The localisation then comprises, successively and on a respective time slot, each of the UWB anchors transmitting a frame 420 (in this example, the system comprises 6 anchors, and 6 frames are therefore received by the portable identifier). Localisation then involves two transmissions 430 of a frame over two final time slots from the UWB portable identifier to each of the UWB anchors of the system.

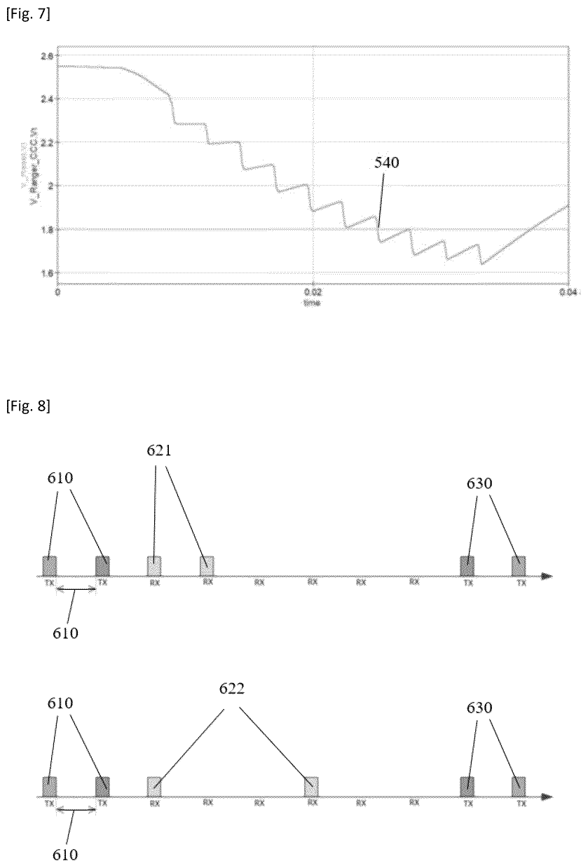

FIG. 6 and FIG. 7 illustrate examples of results. In particular, FIG. 6 shows tables listing the localisation errors when the operating method is not used, i.e., when the localisations are carried out according to the first protocol only. Table 510 shows the results obtained when the energy source is full, Table 520 shows the results obtained when the energy source is discharged by 50 % and the table shows the results obtained when the energy source is discharged by 80 %. The results show that, when the energy source is full, there is no localisation failure (“PASS” for all the temperatures on Table 510). However, when the energy source is discharged by 50 %, localisations fail when the temperature drops below 0° C. (“KO” for temperature rows 0° C., −10° C. and −20° C. in Table 520). When the energy source is discharged by 80 % (Table 530), the results show that the localisations fail from −10° C. when the tank capacitor is 250 μF, from 0° C. when the tank capacitor is 164 μF and from 20° C. when the tank capacitor is 100 μF.

FIG. 7 illustrates an example of these localisation failures carried out using the first communication protocol when the temperature is low and the remaining energy is low. In particular, the figure shows the evolution of the voltage across the terminals of the energy source during localisation. The evolution shows that initially the voltage is sufficient, but that it decreases with each completed exchange, and that at the end of the 7^{th} exchange, 540, it drops below 1.8 V, which results in a localisation failure (with the last exchanges then not being carried out).

The method avoids such localisation failures by changing the communication to the second communication protocol when the temperature is low and the remaining energy is low so that the voltage across the terminals of the electric energy source remains above 1.8 V so that the localisations do not fail.

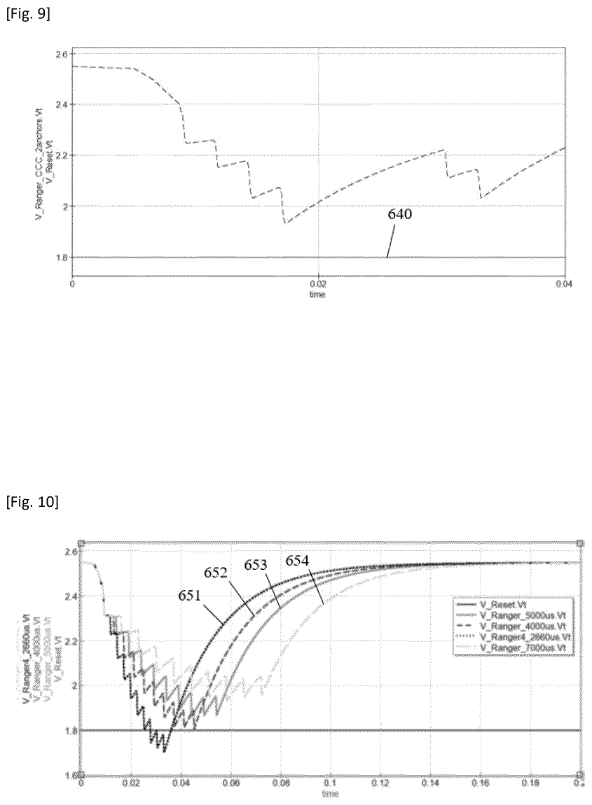

FIG. 8, FIG. 9 and FIG. 10 illustrate examples of localisations carried out using the second communication protocol.

In particular, FIG. 8 shows the first example of an implementation in which the second protocol reduces the number of UWB exchanges carried out for each localisation. In this example, each localisation carried out in the second protocol involves measurements with a smaller number of anchors (for example, two in this example), which reduces the number of completed exchanges, and therefore the energy used. As in the first protocol, localisation initially involves two transmissions of a frame over two first time slots 610 from the portable identifier UWB to each of the UWB anchors of the system. Localisation then involves, successively and over a respective time slot, receiving frames sent by the UWB anchors. In the first protocol, the portable identifier can receive the signals sent by all the anchors of the system (as illustrated in FIG. 5). However, in the second protocol, the portable identifier only picks up a limited number of anchors (two in this example), and therefore only receives the signals from these two anchors 621, 622. The picked-up anchors can vary. For example, in the first example, the first two anchors 621 are picked-up, while in the second example, the first and fourth anchors 622 are picked-up. Localisation then involves two transmissions 630 of a frame over two final time slots from the UWB portable identifier to each of the UWB anchors of the system.

FIG. 9 shows the evolution of the voltage across the terminals of the energy source when the localisation is carried out in the second communication protocol, as illustrated in FIG. 8. The figure shows that the voltage remains above the voltage threshold of 1.8 V, 640. Indeed, since fewer exchanges are carried out, and since they are more spaced apart, the voltage no longer drops below this threshold.

FIG. 10 illustrates the second example of an implementation in which the second protocol increases the time spacing between the UWB exchanges for each localisation. In this second example, the exchanges of signals carried out during each localisation are more spaced apart in the second communication protocol than in the first. This allows the energy that is used to be more spaced apart, and therefore allows the voltage in the energy source to rise between the various exchanges, and therefore to remain above the predetermined voltage threshold. The time spacing between the UWB exchanges of a localisation is illustrated in FIG. 8 and uses reference number 610. FIG. 10 notably shows the evolution of the voltage across the terminals of the energy source when the time spacing is not increased, 651 (2,660 μs), and those obtained for time spacing increases at 4,000 μs, 652, 5,000 μs, 653, and 7,000 μs, 654. The results show that the voltage across the terminals of the energy source remains greater than the voltage threshold of 1.8 V when the time spacing is at least 4,000 μs.

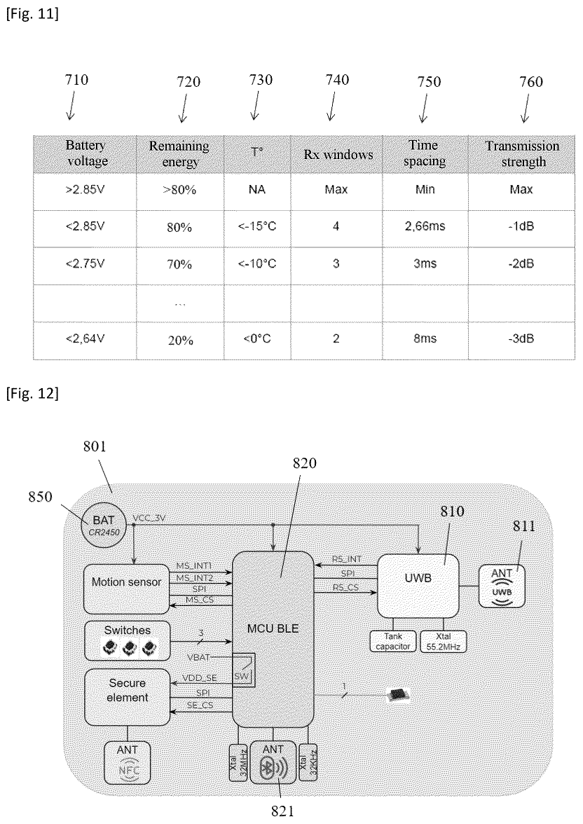

FIG. 11 shows an example of a calibration table. Such a table can be stored in a memory on the portable identifier or the system, and can be used to select the parameters of the second protocol to be implemented as a function of the measured temperature and/or the remaining energy level. The calibration table includes communication protocol parameters to be applied as a function of temperature and energy thresholds. Notably, the calibration table comprises rows corresponding to various situations, and columns indicating, for each situation, the corresponding temperature and remaining energy thresholds, 720, 730, and the parameters to be applied, namely, the maximum number of anchors to be picked-up, 730, the minimum time spacing to be applied, 750, and/or the maximum transmission strength to be used, 760, for the second communication protocol. The selection of the parameters therefore can involve identifying the row of the table corresponding to the current situation by virtue of the indicated temperature and discharge thresholds, then deducing the parameters to be applied by reading the parameters indicated for the identified row. The table can also include a first column 710 indicating the voltages of the energy source corresponding to the various discharges of the column 720. By virtue of this first column 710, it is possible to directly deduce the corresponding discharge as a function of the measured voltage (with this value being more easily measurable).

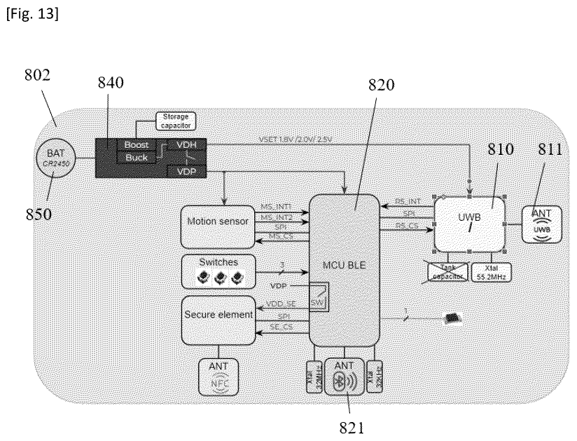

FIG. 12 illustrates a first example of the architecture 801 of the portable identifier. The architecture 800 comprises a UWB component 810 and a BLE component 820. The architecture 800 comprises a UWB antenna 811 connected to the UWB component 810. The architecture 800 comprises a BLE antenna 821 connected to the BLE component 820. The architecture 800 comprises a battery 850 powering the UWB component 810 and the BLE component 820. In this first example, the energy level can be determined by computing the internal resistance of the battery 850 based on measurements of the no-load and load voltages, in order to deduce the remaining energy level therefrom, as explained above. FIG. 13 illustrates a second example of the architecture 802. In this second example, the portable identifier also comprises a voltage converter 840 (also called “voltage booster”), and which is configured to measure the remaining energy level in the battery 850. For example, this component can be configured to provide the amount of energy (for example, the number of mAh) that has been consumed on the electrical energy source. In this second example, the remaining energy level therefore can be deduced from this amount of consumed energy. Alternatively, the remaining energy level can be deduced by computing the internal resistance of the battery 850, as in the first example.

1. A method for using a portable identifier configured to communicate with a vehicle system using a first communication protocol and a second communication protocol, the portable identifier comprising an electrical energy source, the method comprising:
determining a remaining energy level in the electrical energy source;
measuring the a temperature;
detecting that the determined remaining energy level is below a predetermined energy threshold and that the measured temperature is below a predetermined temperature threshold; and
following the detecting, changing a communication from the first communication protocol to the second communication protocol, with the second communication protocol being configured so that a voltage across terminals of the electrical energy source remains above a predetermined voltage threshold.

2. The method according to claim 1, wherein the communication comprises successively localising the portable identifier relative to the vehicle system, with each localisation comprising UWB exchanges between the portable identifier and the vehicle system, with the localisations being carried out, after changing the communication protocol, using the second communication protocol.

3. The method according to claim 2, wherein the localisations carried out using the second communication protocol comprise fewer UWB exchanges than the localisations carried out using the first communication protocol.

4. The method according to claim 3, wherein the vehicle system comprises anchors, with the UWB exchanges for each localisation comprising the portable identifier receiving signals sent by the anchors, with a number of signals received for each localisation carried out using the second communication protocol being less than a number of signals received for each localisation carried out using the first communication protocol.

5. The method according to claim 2, wherein a time spacing between the UWB exchanges for the localisations carried out using the second communication protocol is greater than a time spacing between the UWB exchanges for the localisations carried out using the first communication protocol.

6. The method according to claim 2, wherein the UWB exchanges for each localisation involve comprise the portable identifier transmitting signals to the vehicle system, with a strength of transmissions of the second protocol being lower than a strength of transmissions of the first communication protocol.

7. The method according to claim 2, wherein the portable identifier and/or the vehicle system further comprises a memory storing a calibration table, with the calibration table comprising communication protocol parameters to be applied as a function of temperature and energy thresholds, with the method comprising determining parameters of the second communication protocol by reading the calibration table.

8. The method according to claim 2, wherein measuring the temperature is carried out by the portable identifier or by the vehicle system.

9. (canceled)

10. A non-transitory computer-readable storage medium storing instructions which, when executed by a processor, cause the processor to implement the method according to claim 1.

11. A portable identifier comprising the computer-readable storage medium according to claim 10.
